(19) United States
(12) Patent Application Publication
(10) Pub. No.: US 2007/0055015 A1
(43) Pub. Date: Mar. 8, 2007

(54) Elastomeric fibers comprising controlled distribution block copolymers

(75) Inventors: John E. Flood, Cypress, TX (US); Martin L. Ehrlich, Houston, TX (US)

Correspondence Address: KRATON POLYMERS U.S. LLC, WESTHOLLOW TECHNOLOGY CENTER, 3333 HIGHWAY 6 SOUTH, HOUSTON, TX, 77082, US

(73) Assignee: KRATON Polymers U.S. LLC, Houston, TX (US)

(21) Appl. No.: 11/219,478

(22) Filed: Sep. 2, 2005

(51) Int. Cl. C08L 53/00

(52) U.S. Cl. 525/88

(57) ABSTRACT

Bicomponent fibers comprising a thermoplastic polymer and an elastomeric compound are made which can be continuously extruded from the melt at high production rates. The elastomeric compound comprises a selectively hydrogenated block copolymer having a controlled distribution elastomeric block which has a mono alkenyl arene blockiness index of less than 40 mol % and high flow. Elastomeric fibers are also provided which comprise a controlled distribution block copolymer and a slip agent. The fibers are useful for the manufacture of articles such as woven fabrics, spunbond non-woven fabrics or filters, staple fibers, yarns and bonded, carded webs. The bicomponent fibers can be made using a process comprising coextrusion of the thermoplastic polymer and elastomeric compound to produce fibers at spinning speeds of at least 1000 mpm and having a denier from 0.1 to 50 g/9000 m.

### FIELD OF THE INVENTION

The invention relates to elastomeric fibers comprising a thermoplastic polymer and an elastomeric compound or comprising a slip agent and an elastomeric compound. In particular the elastomeric compound comprises a block copolymer of mono alkenyl arene and conjugated diene having an elastomeric block which is a controlled distribution copolymer of the monoalkenyl arene and the conjugated diene. The invention also relates to processes for producing bicomponent fibers. The invention further relates to articles made from elastomeric fibers.

### BACKGROUND

Fibers made from elastic materials find use in a variety of applications ranging from woven fabrics to spunbond elastic mats to disposable, personal hygiene items. It would be of particular interest to use styrenic block copolymers for such applications. However, the typical phase-separated nature of block copolymer melts leads to high melt elasticity and high melt viscosity. In order to process styrenic block copolymers through small orifices, such as found in fiber spinnerets, expensive and specialized melt pump equipment would be required. Further, the high melt elasticities lead to fracture of the fiber as it exits the die, preventing the formation of continuous elastomeric fibers. As a result, styrenic block copolymers have been found to be exceedingly difficult to process into continuous elastic fibers at high processing rates.

A further problem with styrenic block copolymers is their inherent stickiness in the melt. Because of this character, melt spun fibers of styrenic block copolymers tend to stick together, or self-adhere, during processing. This effect is not desired and can be, in fact, tremendously problematic when separate, continuous fibers are the goal. In addition to the result of an unacceptable fiber product, the self-adhesion of the fibers leads to equipment fouling and expensive shut-downs. Efforts to apply styrenic block copolymers in elastic fiber production have to date been met with significant challenges.

Himes taught the use of triblock/diblock copolymer blends as one approach to make elastomeric fibers in U.S. Pat. No. 4,892,903. These types of compositions have been found to have high viscosities and melt elasticities which have limited them to formation of discontinuous and continuous fibers such as used in melt-blown, non-woven applications.

Bicomponent fibers comprising acid functionalized styrenic block copolymers have been taught by Greak in European Patent Application 0 461 726. Conventional, selectively hydrogenated styrenic block copolymers which were acid functional were used to form side-by-side bicomponent fibers with polyamides. While the acid functionalization provided increased adhesion between the two components, it is well known in the art that acid functionalization may lead to even higher melt viscosities and melt elasticities than in unfunctionalized block copolymers. Further, the acid functionalized fibers or the residual reactive components therein may not be suitable for all applications since the acid or residuals may act as an irritant or sensitizer. Even further, the side-by-side morphologies taught by Greak would not prevent the inherently sticky fibers from self-adhering during processing.

Bonded non-woven webs made using bicomponent fibers comprising, among other polymers, conventional styrenic block copolymers and having a variety of morphologies has been taught by Austin in U.S. Pat. No. 6,225,243. In particular, the sheath-core morphologies, with the core being comprised of conventional styrenic block copolymers, provided fibers of suitably low stickiness to form non-woven webs.

However, the high viscosity and melt elasticity of conventional styrenic block copolymers continues to prevent high speed spinning of continuous elastomeric fibers. The present invention addresses these longstanding needs by providing a high melt flow block copolymer which is able to be formed into continuous elastomeric fibers. In particular, it has been surprisingly found that block copolymers having a controlled distribution elastomeric block make excellent elastomeric components of bicomponent fibers by themselves or in combination with other polymers or compounding ingredients. Further, when the controlled distribution block copolymeric elastomer is compounded with a sufficient amount of slip agent, high spinning speeds and outstanding elasticity are achieved in mono-component fibers. This invention provides highly processable, non-stick fibers possessing mechanical properties heretofore unattainable.

### SUMMARY OF THE INVENTION

In one aspect, the present invention is a bicomponent fiber comprising a thermoplastic polymer and an elastomeric compound wherein the elastomeric compound comprises a selectively hydrogenated block copolymer having the general configuration A-B, A-B-A, (A-B)ₙ, (A-B-A)ₙ, (A-B-A)ₙX, (A-B)ₙX or mixtures thereof where n is an integer from 2 to about 30, and X is coupling agent residue and wherein:
a. prior to hydrogenation each A block is a mono alkenyl arene polymer block and each B block is a controlled distribution copolymer block of at least one conjugated diene and at least one mono alkenyl arene;
b. subsequent to hydrogenation about 0-10 % of the arene double bonds have been reduced, and at least about 90% of the conjugated diene double bonds have been reduced;
c. each A block having a number average molecular weight between about 3,000 and about 60,000 and each B block having a number average molecular weight between about 30,000 and about 300,000;
d. each B block comprises terminal regions adjacent to the A block that are rich in conjugated diene units and one or more regions not adjacent to the A block that are rich in mono alkenyl arene units;
e. the total amount of mono alkenyl arene in the hydrogenated block copolymer is about 20 percent weight to about 80 percent weight; and
f. the weight percent of mono alkenyl arene in each B block is between about 10 percent and about 75 percent;
g. each block B has a mono alkenyl arene blockiness index of less than 40 mol %, said mono alkenyl arene blockiness index being the proportion of mono alkenyl arene units in the block B having two mono alkenyl arene neighbors on the polymer chain; and
h. the melt index of the block copolymer is greater than or equal to 12 grams/10 minutes according to ASTM D1238 at 230° C. and 2.16 kg weight.

In another aspect the invention is an article such as an elastomeric mono filament, a woven fabric, a spunbond non-woven fabric, a melt blown non-woven fabric or filter, a staple fiber, a yarn or a bonded, carded web comprising the bicomponent fiber described herein.

In a further aspect the invention is a process to produce a bicomponent fiber comprising coextrusion of a thermoplastic polymer and an elastomeric compound comprising a selectively hydrogenated controlled distribution block copolymer as described herein wherein the thermoplastic polymer and the elastomeric compound are forced using separate melt pumps through a die to form one or more fibers having a sheath or matrix primarily composed of thermoplastic polymer and a core or islands comprised of the elastomeric compound at a spinning speed of at least 1000 meters per minute such that the resulting bicomponent fiber has a denier per filament of 0.1 to 10 grams per 9000 meters.

In an even further aspect, the invention is an elastomeric fiber made of a selectively hydrogenated controlled distribution block copolymer and a slip agent.

Importantly, the invention comprises an elastomeric compound having high melt flow which allows processing of bicomponent fibers on commercial-type equipment at high rates. The high melt flow of the elastomeric compound can be achieved with selectively hydrogenated block copolymers having controlled distribution elastomeric blocks.

The elastomeric compound may further comprise a thermoplastic polymer which is compositionally the same or different from the sheath or matrix material. Incorporation of a thermoplastic polymer in the elastomeric compound may increase the core-sheath or island-sea compatibility and/or adhesion, increase the processability of the elastomeric compound, and/or improve the material economics.

### FIGURES

FIG. 1 shows a cross-section of a bundle of bicomponent fibers of the present invention having an islands-in-the-sea morphology. The elastomeric compound makes up the microfibers embedded in the thermoplastic polymer matrix.

FIG. 2 shows a cross-section of a bundle of bicomponent fibers of the present invention having a sheath-core morphology. The thermoplastic polymer sheath is apparent as an annular region surrounding each elastomeric compound core.

### DETAILED DESCRIPTION OF THE PREFERRED EMBODIMENTS

The bicomponent fibers of the present invention comprise a thermoplastic polymer sheath and an elastomeric compound core comprising a selectively hydrogenated controlled distribution block copolymer. The bicomponent fiber is made by a coextrusion process in which the thermoplastic polymer and the elastomeric compound core are metered to a die or spinneret separately. Such a coextruded bicomponent fiber can have a variety of morphologies including, but not limited to, sheath-core, side-by-side, islands in the sea, bilobal, trilobal, and pie-section.

In the sheath-core embodiment of the present invention it is important that the sheath form the majority of the outside surface of the fiber. In particular, the sheath-core morphology wherein the sheath forms a covering about the core is one preferred embodiment. In this preferred morphology, the core may be centered in the fiber cross-section or may be off-center. The sheath may cover the core in a complete fashion over the circumference of the fiber or may be only partially covering over the circumference of the fiber. In the case where the covering is partial about the circumference, the core makes up the majority of the volume of the fiber. The volume ratio of the sheath to the core in the present invention is from 1/99 to 50/50. The preferred range of sheath to core volume ratio is 5/95 to 40/60 and the most preferred range is 10/90 to 30/70. The sheath consists primarily of a thermoplastic polymer and the core consists of an elastomeric compound. As used herein “consists primarily” means greater than 80% on a volume basis.

In the islands-in-the-sea embodiment of the present invention it is important that the sea form a continuous matrix in which the islands exist. The islands-in-the-sea morphology is another preferred embodiment. The islands are referred to as such because of their appearance in cross-sectional views of the coextruded bicomponent fiber. The islands are actually microfibrous elements embedded in the continuous sea matrix. In this preferred embodiment the sea consists primarily of a thermoplastic polymer and the islands consist primarily of an elastomeric compound. The volume ratio of the sea to the islands in the present invention is from 1/99 to 50/50. The preferred range of sea to island volume ratio is from 5/95 to 40/60 and the most preferred range is from 10/90 to 30/70. It is well known in the art that free-standing microfibers can be produced from coextruded bicomponent fibers having islands-in-the-sea morphologies. Such microfibers are obtained by removing the sea matrix by a process such as selective dissolution. In this way, the free-standing microfibers remain. The bicomponent fibers of the present invention are suitable for producing elastomeric microfibers comprising the controlled distribution block copolymer.

The elastomeric compound core comprises block copolymers having a controlled distribution elastomeric block. These controlled distribution block copolymers result from the copolymerization of alkenyl arenes and dienes as part of a mono alkenyl arene/conjugated diene block copolymer. Surprisingly, the combination of (1) a unique control for the monomer addition and (2) the use of diethyl ether or other modifiers as a component of the solvent (which will be referred to as “distribution agents”) results in a certain characteristic distribution of the two monomers (herein termed a “controlled distribution” polymerization, i.e., a polymerization resulting in a “controlled distribution” structure), and also results in the presence of certain mono alkenyl arene rich regions and certain conjugated diene rich regions in the polymer block. For purposes hereof, “controlled distribution” is defined as referring to a molecular structure having the following attributes: (1) terminal regions adjacent to the mono alkenyl arene homopolymer (“A”) blocks that are rich in conjugated diene units; (2) one or more regions not adjacent to the A blocks that are rich in mono alkenyl arene units; and (3) an overall structure having relatively low blockiness. For the purposes hereof, “rich in” means greater than the average amount, preferably greater than 5% of the average amount. The relatively low blockiness of the controlled distribution (“B”) blocks can be shown by either the presence of only a single glass transition (Tg) intermediate between the Tg's of either monomer alone, when analyzed using differential scanning calorimetry (“DSC”) (thermal) methods or via mechanical methods, or as shown via proton nuclear magnetic resonance (“H1-NMR”) methods. The potential for blockiness can also be inferred from measurement of the UV-visible absorbance in a wavelength range suitable for the detection of polystyryllithium end groups during the polymerization of the B block. A sharp and substantial increase in this value is indicative of a substantial increase in polystyryllithium chain ends. In this process, this will only occur if the conjugated diene concentration drops below the critical level necessary to maintain controlled distribution polymerization. Any styrene monomer that is present at this point will add in a blocky fashion. The term “styrene blockiness”, as measured by those skilled in the art using proton NMR, is defined to be the proportion of S units in the polymer having two S nearest neighbors on the polymer chain. The styrene blockiness is determined after using H1-NMR to measure two experimental quantities as follows:

First, the total number of styrene units (i.e. arbitrary instrument units which cancel out when ratioed) is determined by integrating the total styrene aromatic signal in the H1-NMR spectrum from 7.5 to 6.2 ppm and dividing this quantity by 5 to account for the 5 aromatic hydrogens on each styrene aromatic ring.

Second, the blocky styrene units are determined by integrating that portion of the aromatic signal in the H1-NMR spectrum from the signal minimum between 6.88 and 6.80 to 6.2 ppm and dividing this quantity by 2 to account for the 2 ortho hydrogens on each blocky styrene aromatic ring. The assignment of this signal to the two ortho hydrogens on the rings of those styrene units which have two styrene nearest neighbors was reported in F. A. Bovey, High Resolution NMR of Macromolecules (Academic Press, New York and London, 1972), chapter 6.
The styrene blockiness is simply the percentage of blocky styrene to total styrene units: Blocky %=100 times (Blocky Styrene Units/Total Styrene Units)
Expressed thus, Polymer-Bd-S-(S)n-S-Bd-Polymer, where n is greater than zero is defined to be blocky styrene. For example, if n equals 8 in the example above, then the blockiness index would be 80%. It is preferred that the blockiness index be less than about 40% and more preferred less than about 25%. For some polymers, having styrene contents of 10 weight percent to 40 weight percent, it is preferred that the blockiness index be less than about 10%.

As used herein, “thermoplastic block copolymer” is defined as a block copolymer having at least a first block of one or more mono alkenyl arenes (A block), such as styrene and a second block of a controlled distribution copolymer (B block) of diene and mono alkenyl arene. The method to prepare this thermoplastic block copolymer is via any of the methods generally known for block polymerizations. The present invention includes as an embodiment a thermoplastic copolymer composition, which may be either a di-block copolymer, tri-block copolymer, tetra-block copolymer or multi-block copolymer composition. In the case of the di-block copolymer composition, one block is the alkenyl arene-based homopolymer block and polymerized therewith is a second block of a controlled distribution copolymer of diene and alkenyl arene. In the case of the tri-block copolymer composition, it comprises, as end-blocks the glassy alkenyl arene-based homopolymer and as a mid-block the controlled distribution copolymer of diene and alkenyl arene. Where a tri-block copolymer composition is prepared, the controlled distribution diene/alkenyl arene copolymer can be herein designated as “B” and the alkenyl arene-based homopolymer designated as “A”. The A-B-A, tri-block copolymer compositions can be made by either sequential polymerization or coupling. In the sequential solution polymerization technique, the mono alkenyl arene is first introduced to produce the relatively hard aromatic block, followed by introduction of the controlled distribution diene/alkenyl arene mixture to form the mid block, and then followed by introduction of the mono alkenyl arene to form the terminal block. In addition to the linear, A-B-A configuration, the blocks can be structured to form a radial (branched) polymer, (A-B)ₙX, or both types of structures can be combined in a mixture. Some A-B diblock polymer can be present but preferably at least about 70 weight percent of the block copolymer is A-B-A or radial (or otherwise branched so as to have 2 or more terminal resinous blocks per molecule) so as to impart strength.

The controlled distribution structure is very important in managing the strength and Tg of the resulting thermoplastic elastomer. In the controlled distribution structure the styrene blockiness is low and this ensures that there is virtually no phase separation of the two monomers. This is in contrast to copolymers in which the monomers actually remain as separate “microphases”, and thereby have separate and distinct Tg's. Because only one Tg is present in the controlled distribution copolymer, the thermal performance of the resulting copolymer is predictable and, in fact, predeterminable.

An important feature of the thermoplastic elastomeric di-block, tri-block, multi-block and radial block copolymers of the present invention, including one or more controlled distribution diene/alkenyl arene copolymer blocks (B block) and one or more mono alkenyl arene (A block), is the separate Tg's of the A and B blocks. The Tg of the alkenyl arene A blocks is higher than the Tg of the controlled distribution copolymer B blocks. The Tg of the controlled distribution block is preferably at least about −60 degrees C., more preferably from about −40 degrees C. to about +30 degrees C., and most preferably from about −40 degrees C. to about +10 degrees C. The higher Tg of the alkenyl arene A blocks is preferably from about +80 degrees C to about +110 degrees C, more preferably from about +80 degrees C to about +105 degrees C.

When such a controlled distribution structure is used as one block in a di-block, tri-block or multi-block copolymer, the presence of an appropriately-constituted controlled distribution copolymer region will tend to improve flow and processability.

In a preferred embodiment of the present invention, the subject controlled distribution copolymer block has two distinct types of regions: conjugated diene rich regions on the ends of the block; and, a mono alkenyl arene rich region near the middle or center of the block. What is desired is a mono alkenyl arene/conjugated diene controlled distribution copolymer block, wherein the proportion of mono alkenyl arene units increases gradually to a maximum near the middle or center of the block. This structure is distinct and different from the tapered and/or random structures discussed in the prior art.

As discussed above, the controlled distribution polymer block has diene rich region(s) adjacent to the A block and an arene rich region not adjacent to the A block, and typically near the center of the B block. Typically the region adjacent to the A block comprises the first 15 to 25% of the block and comprises the diene rich region(s), with the remainder considered to be arene rich. The term “diene rich” means that the region has a measurably higher ratio of diene to arene than the arene rich region. Another way to express this is the proportion of mono alkenyl arene units increases gradually along the polymer chain to a maximum near the middle or center of the block (if we are describing an ABA structure) and then decreases gradually until the polymer block is fully polymerized. For the controlled distribution block B, the weight percent of mono alkenyl arene is between about 10% and about 75%. In a more preferred embodiment the mono alkenyl arene content is between about 10% and about 50% by weight.

The block copolymers of the present invention are prepared by anionic polymerization of styrene and a diene selected from the group consisting of butadiene, isoprene and mixtures thereof. The polymerization is accomplished by contacting the styrene and diene monomers with an organoalkali metal compound in a suitable solvent at a temperature within the range from about −150° C. to about 300° C., preferably at a temperature within the range from about 0° C. to about 100° C. Particularly effective anionic polymerization initiators are organolithium compounds having the general formula RLiₙ where R is an aliphatic, cycloaliphatic, aromatic, or alkyl-substituted aromatic hydrocarbon radical having from 1 to 20 carbon atoms; and n has a value of 1 to 4. Preferred initiators include n-butyl lithium and sec-butyl lithium. Methods for anionic polymerization are well known and can be found in such references as U.S. Pat. Nos. 4,039,593 and U.S. Reissue Pat. No. Re 27,145.

The block copolymers of the present invention can be linear, linear coupled, or a radial block copolymer having a mixture of 2 to 6 “arms”. Linear block copolymers can be made by polymerizing mono alkenyl arene to form a first S block, forming a controlled distribution block B comprising mono alkenyl arene and conjugated diene, and then adding additional mono alkenyl arene to form a second S block. A linear coupled block copolymer is made by forming the first S block and B block and then contacting the diblock with a difunctional coupling agent. A radial block copolymer is prepared by using a coupling agent that is at least trifunctional.

Difunctional coupling agents useful for preparing linear block copolymers include, for example, methyl benzoate as disclosed in U.S. Pat. No. 3,766,301. Other coupling agents having two, three or four functional groups useful for forming radial block copolymers include, for example, silicon tetrachloride and alkoxy silanes as disclosed in U.S. Pat. Nos. 3, 244,664, 3,692,874, 4,076,915, 5,075,377, 5,272,214 and 5,681,895; polyepoxides, polyisocyanates, polyimines, polyaldehydes, polyketones, polyanhydrides, polyesters, polyhalides as disclosed in U.S. Pat. No. 3,281,383; diesters as disclosed in U.S. Pat. No. 3,594,452; methoxy silanes as disclosed in U.S. Pat. No. 3,880,954; divinyl benzene as disclosed in U.S. Pat. No. 3,985,830; 1,3,5-benzenetricarboxylic acid trichloride as disclosed in U.S. Pat. No. 4,104,332; glycidoxytrimethoxy silanes as disclosed in U.S. Pat. No. 4,185,042; and oxydipropylbis(trimethoxy silane) as disclosed in U.S. Pat. No. 4,379,891.

In one embodiment of the present invention, the coupling agent used is an alkoxy silane of the general formula Rₓ—Si—(OR′)_{y}, where x is 0 or 1, x+y=3 or 4, R and R′ are the same or different, R is selected from aryl, linear alkyl and branched alkyl hydrocarbon radicals, and R′ is selected from linear and branched alkyl hydrocarbon radicals. The aryl radicals preferably have from 6 to 12 carbon atoms. The alkyl radicals preferably have 1 to 12 carbon atoms, more preferably from 1 to 4 carbon atoms. Under melt conditions these alkoxy silane coupling agents can couple further to yield functionalities greater than 4. Preferred tetra alkoxy silanes are tetramethoxy silane (“TMSi”), tetraethoxy silane (“TESi”), tetrabutoxy silane (“TBSi”), and tetrakis(2-ethylhexyloxy)silane (“TEHSi”). Preferred trialkoxy silanes are methyl trimethoxy silane (“MTMS”), methyl triethoxy silane (“MTES”), isobutyl trimethoxy silane (“IBTMO”) and phenyl trimethoxy silane (“PhTMO”). Of these the more preferred are tetraethoxy silane and methyl trimethoxy silane.

The hydrogenated block copolymers of the present invention are selectively hydrogenated using any of the several hydrogenation processes known in the art. For example the hydrogenation may be accomplished using methods such as those taught, for example, in U.S. Pat. Nos. 3,494,942; 3,634,594; 3,670,054; 3,700,633; and Re. 27,145, the disclosures of which are hereby incorporated by reference. Any hydrogenation method that is selective for the double bonds in the conjugated polydiene blocks, leaving the aromatic unsaturation in the polystyrene blocks substantially intact, can be used to prepare the hydrogenated block copolymers of the present invention.

The methods known in the prior art and useful for preparing the hydrogenated block copolymers of the present invention involve the use of a suitable catalyst, particularly a catalyst or catalyst precursor comprising an iron group metal atom, particularly nickel or cobalt, and a suitable reducing agent such as an aluminum alkyl. Also useful are titanium based catalyst systems. In general, the hydrogenation can be accomplished in a suitable solvent at a temperature within the range from about 20° C. to about 100° C., and at a hydrogen partial pressure within the range from about 100 psig (689 kPa) to about 5,000 psig (34,473 kPa). Catalyst concentrations within the range from about 10 ppm to about 500 ppm by wt of iron group metal based on total solution are generally used and contacting at hydrogenation conditions is generally continued for a period of time with the range from about 60 to about 240 minutes. After the hydrogenation is completed, the hydrogenation catalyst and catalyst residue will, generally, be separated from the polymer.

In the practice of the present invention, the hydrogenated controlled distribution block copolymers have a hydrogenation degree greater than 80 percent. This means that more than from 80 percent of the conjugated diene double bonds in the elastomeric B block has been hydrogenated from an alkene to an alkane. In one embodiment, the elastomeric B block has a hydrogenation degree greater than about 90 percent. In another embodiment, the elastomeric B block has a hydrogenation degree greater than about 95 percent.

The alkenyl arene monomers of the controlled distribution block copolymer can be selected from styrene, alpha-methylstyrene, para-methylstyrene, vinyl toluene, vinylnaphthalene, and para-butyl styrene or mixtures thereof. Of these, styrene is most preferred and is commercially available, and relatively inexpensive, from a variety of manufacturers. The conjugated dienes for use herein are 1,3-butadiene and substituted butadienes such as isoprene, piperylene, 2,3-dimethyl-1,3-butadiene, and 1-phenyl-1,3-butadiene, or mixtures thereof. Of these, 1,3-butadiene is most preferred. As used herein, and in the claims, “butadiene” refers specifically to “1,3-butadiene”.

For the controlled distribution or elastomeric B block the weight percent of mono alkenyl arene in each B block is between about 10 weight percent and about 75 weight percent, preferably between about 25 weight percent and about 50 weight percent for selectively hydrogenated polymers.

It is also important to control the molecular weight of the various blocks. For an AB diblock, desired block weights are 3,000 to about 60,000 for the mono alkenyl arene A block, and 30,000 to about 300,000 for the controlled distribution conjugated diene/mono alkenyl arene B block. Preferred ranges are 5000 to 45,000 for the A block and 50,000 to about 250,000 for the B block. For the triblock, which may be a sequential ABA or coupled (AB)₂ X block copolymer, the A blocks should be 3,000 to about 60,000, preferably 5000 to about 45,000, while the B block for the sequential block should be about 30,000 to about 300,000, and the B blocks (two) for the coupled polymer half that amount. The total average molecular weight for the triblock copolymer, either sequentially made or coupled, should be from about 40,000 to about 400,000, and for the radial copolymer from about 60,000 to about 600,000. For the tetrablock copolymer ABAB the block size for the terminal B block should be about 2,000 to about 40,000, and the other blocks may be similar to that of the sequential triblock copolymer.

The molecular weights referred to in this specification and claims can be measured with gel permeation chromatography (GPC) using polystyrene calibration standards, such as is done according to ASTM 3536. GPC is a well-known method wherein polymers are separated according to molecular size, the largest molecule eluting first. The chromatograph is calibrated using commercially available polystyrene molecular weight standards. The molecular weight of polymers measured using GPC so calibrated are styrene equivalent molecular weights. The styrene equivalent molecular weight may be converted to true molecular weight when the styrene content of the polymer and the vinyl content of the diene segments are known. The detector used is preferably a combination ultraviolet and refractive index detector. The molecular weights expressed herein are measured at the peak of the GPC trace, converted to true molecular weights, and are commonly referred to as “peak molecular weights”.

An important aspect of the present invention is to control the microstructure or vinyl content of the conjugated diene in the controlled distribution copolymer block. The term “vinyl content” refers to the fact that a conjugated diene is polymerized via 1,2-addition (in the case of butadiene—it would be 3,4-addition in the case of isoprene). Although a pure “vinyl” group is formed only in the case of 1,2-addition polymerization of 1,3-butadiene, the effects of 3,4-addition polymerization of isoprene (and similar addition for other conjugated dienes) on the final properties of the block copolymer will be similar. The term “vinyl” refers to the presence of a pendant vinyl group on the polymer chain. When referring to the use of butadiene as the conjugated diene, it is preferred that about 20 to about 80 mol percent of the condensed butadiene units in the copolymer block have 1,2 vinyl configuration as determined by proton NMR analysis. For selectively hydrogenated block copolymers, preferably about 30 to about 70 mol percent of the condensed butadiene units should have 1,2 configuration. For unsaturated block copolymers, preferably about 20 to about 40 mol percent of the condensed butadiene units should have 1,2-vinyl configuration. This is effectively controlled by varying the relative amount of a distribution agent. The distribution agent employed during polymerization is typically a non-chelating ether such as diethyl ether or ortho-dimethoxy benzene. As will be appreciated, the distribution agent serves two purposes—it creates the controlled distribution of the mono alkenyl arene and conjugated diene, and also controls the microstructure of the conjugated diene. Suitable ratios of distribution agent to lithium are disclosed and taught in U.S. Pat. Re No. 27,145, which disclosure is incorporated by reference.

One advantage of the controlled distribution block copolymers of the present invention over conventional hydrogenated block copolymers is that they have high melt flows that allow them to be easily molded or continuously extruded into shapes or films or spun into fibers. This property allows end users to avoid or at least limit the use of additives that degrade properties, cause area contamination, smoking, and even build up on molds and dies.

One characteristic of the hydrogenated block copolymers of the present invention is that they have a low order-disorder temperature. The order-disorder temperature (ODT) of the hydrogenated block copolymers of the present invention is typically less than about 250° C. Above 250° C. the polymer is more difficult to process although in certain instances for some applications ODT's greater than 250° C. can be utilized. One such instance is when the block copolymer is combined with other components to improve processing. Such other components may be thermoplastic polymers, oils, resins, waxes or the like. In one embodiment, the ODT is less than about 240° C. Preferably, the hydrogenated block copolymers of the present invention have an ODT of from about 210° C. to about 240° C. This property can be important in some applications because when the ODT is below 210° C., the block copolymer may exhibit creep that is undesirably excessive or low strength. For purposes of the present invention, the order-disorder temperature is defined as the temperature above which a zero shear viscosity can be measured by capillary rheology or dynamic rheology.

For the purposes of the present invention, the term “melt index” is a measure of the melt flow of the polymer according ASTM D1238 at 230° C. and 2.16 kg weight. It is expressed in units of grams of polymer passing through a melt rheometer orifice in 10 minutes. The hydrogenated controlled distribution block copolymers of the present invention have a desirable high melt index allowing easy processing. In one embodiment, the hydrogenated block copolymers of the present invention have a melt index of greater than or equal to 12. In another embodiment, the hydrogenated block copolymers of the present invention have a melt index of at least 15. In still another embodiment, the hydrogenated block copolymers of the present invention have a melt index of at least 40. Another embodiment of the present invention includes hydrogenated block copolymers having a melt index of from about 20 to about 100. Still another embodiment of the present invention includes hydrogenated block copolymers having a melt index of from about 50 to about 85.

In a further embodiment, the elastomeric compound core is further comprised of a thermoplastic polymer. In this embodiment, the elastomeric core contains up to 50% by weight of a thermoplastic polymer such as polypropylene, linear low density polyethylene, polystyrene, polyamides, polyesters such as poly(ethylene terephthalate), poly(butylene terephthalate), and poly(trimethylene terephthalate) and other thermoplastics as described herein in reference to the thermoplastic polymer composition.

The bicomponent fiber of the present invention includes a sheath or matrix composed primarily of a thermoplastic polymer. Exemplary thermoplastic polymers include, for example, ethylene homopolymers, ethylene/alpha-olefin copolymers, propylene homopolymers, propylene/alpha-olefin copolymers, impact polypropylene copolymers, butylene homopolymers, butylene/alpha olefin copolymers, and other alpha olefin copolymers or interpolymers.

Representative polyethylenes include, for example, but are not limited to, substantially linear ethylene polymers, homogeneously branched linear ethylene polymers, heterogeneously branched linear ethylene polymers, including linear low density polyethylene (LLDPE), ultra or very low density polyethylene (ULDPE or VLDPE), medium density polyethylene (MDPE), high density polyethylene (HDPE) and high pressure low density polyethylene (LDPE). When the thermoplastic polymer is polyethylene, the melt flow rate, also referred to as melt flow index, must be at least 10 g/10 min at 190° C. and 2.16 kg weight according to ASTM D1238. The preferred type of polyethylene is linear low density polyethylene.

Representative polypropylenes include, for example, but are not limited to, substantially isotactic propylene homopolymers, random alpha olefin/propylene copolymers where propylene is the major component on a molar basis and polypropylene impact copolymers where the polymer matrix is primarily a polypropylene homopolymer or random copolymer and the rubber phase is an alpha-olefin/propylene random copolymer. Suitable melt flow rates of polypropylenes are at least 10 g/10 min at 230° C. and 2.16 kg according to ASTM D1238. More preferred are melt flow rates of at least 20 g/10 min. Most preferred are melt flow rates of at least 30 g/10 min. Polypropylene homopolymers are the preferred type of polypropylene.

Examples of ethylene/alpha-olefin copolymers and propylene/alpha-olefin copolymers include, but are not limited to, AFFINITY, ENGAGE and VERSIFY polymers from Dow Chemical and EXACT and VISTAMAXX polymers from Exxon Mobil. Suitable melt flow rates of such copolymers must be at least 10 g/10 min at 230° C. and 2.16 kg weight according to ASTM D1238. Preferred for the present invention are melt flow rates of at least 20g/10 min and most preferred are melt flow rates of at least 30g/10 min.

Still other thermoplastic polymers included herein are polyvinyl chloride (PVC) and blends of PVC with other materials, polystyrene, polyamides such as nylon 6 and nylon 66, and polyesters such as poly(ethylene terephthalate), poly(butylene terephthalate) and poly(trimethylene terephthalate). Regardless of the specific type, the thermoplastic polymer must have a viscosity suitable for processing into fibers or components of fibers. Suitable polyesters have limiting viscosity numbers (LVN) of at least 0.5 and the preferred range is from 0.5 to 3.

The slip agents of the present invention serve to enhance the processability of the elastomer compound and reduce the fiber stickiness. As such, high extrusion rates and spinning speeds are achievable. Suitable slip agents include low molecular weight amides, metallic stearates such as calcium and zinc stearates and the like, silicones, fluorinated hydrocarbons, acrylics and silicones, waxes and the like. Examples of suitable primary amides are behanamide (available as Crodamide BR from Croda, and ARMOSLIP® B from Akzo Nobel), erucamide (available as Crodamide E from Croda, ARMOSLIP E from Akzo Nobel, and ATMER® SA 1753 from Uniqema), oleamide (available as Crodamide VRX from Croda, ARMOSLIP CP from Akzo Nobel, and ATMER SA 1758 from Uniqema), and stearamide (available as Crodamide SR from Croda, ARMOSLIP 18 LF from Akzo Nobel, and ATMER SA 1750 from Uniqema). Examples of suitable secondary amines are oleyl palitamide (available as Crodamide 203 from Croda) and stearyl erucamide (available as Crodamide 212 from Croda). Both saturated and unsaturated amides are suitable.

The slip agents are used in an amount ranging from 0.01 to 2.0 parts by weight for 99.99 to 95 parts by weight of elastomeric compound. More preferred is 0.1 to 1.0 parts by weight of slip agent for 99.9 to 98 parts by weight of elastomeric compound.

It is sometimes desirable to use other additives in the elastomer compound. Exemplary of such additives are members selected from the group consisting of other block copolymers, olefin polymers, styrene polymers, tackifying resins, polymer extending oils, waxes, fillers, reinforcements, lubricants, stabilizers, and mixtures thereof.

In the embodiments of the present invention it is especially useful to include resins compatible with the elastomeric controlled distribution blocks of the elastomeric compound. This serves to promote the flow of the elastomeric compound. Various resins are known, and are discussed, e.g., in U.S. Pat. Nos. 4,789,699; 4,294,936; and 3,783,072, the contents of which, with respect to the resins, are incorporated herein by reference. Any resin can be used which is compatible with the rubber E and/or E₁ blocks of the elastomeric compound and/or the polyolefin, and can withstand the high processing (e.g., extrusion) temperatures. Generally, hydrogenated hydrocarbon resins are preferred resins, because of their better temperature stability. Examples illustrative of useful resins are hydrogenated hydrocarbon resins such as low molecular weight, fully hydrogenated α-methylstyrene REGALREZ® (Eastman Chemical), ARKON®P (Arakawa Chemical) series resins, and terpene hydrocarbons such as ZONATAC®501 Lite (Arizona Chemical). The present invention is not limited to use of the resins listed here. In general, the resin may be selected from the group consisting of C₅ hydrocarbon resins, hydrogenated C₅ hydrocarbon resins, styrenated C₅ resins, C₅/C₉ resins, styrenated terpene resins, fully hydrogenated or partially hydrogenated C₉ hydrocarbon resins, rosin esters, rosin derivatives and mixtures thereof. One of ordinary skill in the art will understand that other resins which are compatible with the components of the composition and can withstand the high processing temperatures, and can achieve the objectives of the present invention, can also be used.

The elastomer fiber may also comprise a wax to promote flow and/or compatibility. Suitable amounts of wax are from 0.1 to 30% w, preferably from 1 to 15% wt based on the weight of the elastomeric compound. Animal, insect, vegetable, synthetic and mineral waxes may be used with those derived from mineral oils being preferred. Examples of mineral oil waxes include bright stock slack wax, medium machine oil slack wax, high melting point waxes and microcrystalline waxes. In the case of slack waxes up to 25% w of oil may be present. Additives to increase the congealing point of the wax may also be present.

The elastomeric fiber may also comprise oil. The oil may be incorporated to improve the processability of the fiber or to enhance its softness. Especially preferred are the types of oil that are compatible with the controlled distribution elastomeric block of the block copolymer. While oils of higher aromatics content are satisfactory, those petroleum-based white oils having low volatility and less than 50% aromatic content are preferred. The oils should additionally have low volatility, preferable having an initial boiling point above about 260° C. The amount of oil employed varies from about 0 to about 300 parts by weight per hundred parts by weight rubber, or block copolymer, preferably about 20 to about 150 parts by weight.

The elastomeric compound is typically stabilized by the addition of an antioxidant or mixture of antioxidants. Frequently, a sterically hindered phenolic stabilizer is used, or a phosphorus-based stabilizer is used in combination with a sterically hindered phenolic stabilizer, such as disclosed in Japanese patent No. 94055772; or a combination of phenolic stabilizers is used, such as disclosed in Japanese patent No. 94078376.

Other additives such as pigments, dyes, optical brighteners, bluing agents and flame retardants may be used in the elastomeric fibers of the present invention.

The elastomeric fibers of the present invention can be used to form a variety of articles. These articles include elastic mono-filaments, woven fabrics, spunbond non-woven fabrics or filters, melt-blown fabrics, staple fibers, yarns, bonded, carded webs, and the like. Any of the processes typically used to make these articles can be employed.

In particular, non-woven fabrics or webs can be formed by any of the processes known in the art. One process, typically referred to as spunbond, is well known in the art. U.S. Pat. No. 4,405,297 describes a typical spunbond processes. The spunbond process commonly comprises extruding the fibers from the melt through a spinneret, quenching and/or drawing the fibers using an air flow, and collecting and bonding the non-woven web. The bonding of the non-woven web is typically accomplished by any thermal, chemical or mechanical methods, including water, sonic or pneumatic entanglement and needle punch processes, effective in creating a multiplicity of intermediate bonds among the fibers of the web. The non-woven webs of the present invention can also be formed using melt-blown process such as described in U.S. Pat. No. 5,290,626. Carded webs may be formed from non-woven webs by folding and bonding the non-woven web upon itself in the cross machine direction.

The non-woven fabrics of the present invention can be used for a variety of elastic fabrics such as diapers, waist bands, stretch panels, disposable garments, medical and personal hygiene articles, filters, and the like.

Elastic mono-filaments of the present invention are continuous, single, elastomeric fibers used for a variety of purposes and can be formed by any of the known methods of the art comprising spinning, drawing, quenching and winding. As used herein, staple fiber means cut or chopped segments of the continuously coextruded bicomponent fiber.

Yams of the elastomeric fibers can be formed by common processes. U.S. Pat. No. 6,113,825 teaches the general process of yarn formation. In general, the process comprises melt extrusion of multiple fibers from a spinneret, drawing and winding the fibers together to form a multi-filament yarn, extending or stretching the yarn optionally through one or more thermal treatment zones, and cooling and winding the yarn.

The articles of the present invention can be used alone or in combination with other articles made with the elastomeric fibers or with other classes of materials. As an example, non-woven webs can be combined with elastic mono-filaments to provide elastic stretch panels. As another example, non-woven webs can be bonded to other non-elastomeric non-woven webs or polymeric films of many types.

In the process of producing the bicomponent fiber of the present invention two separate single screw extruders are used to extrude the thermoplastic polymer and elastomeric compound into two separate melt pumps. Following the melt pumps, the polymers are brought together into their bicomponent configuration in the spinneret via a series of plates and baffles. Upon exiting the spinneret the fibers are cooled/quenched via a cold air quench cabinet. After quenching the fibers are drawn via an aspirator or a series of cold rolls. In the case that cold rolls are used, the fibers are taken up onto a winder. In the case that an aspirator is used, the fibers can be collected in a suitable vessel beneath the aspirator or are spun directly onto a substrate of interest to form a non-woven article, for example.

One important aspect of the process is the rate at which the elastomeric fibers may be produced. The high flow characteristics presented by the inventive fibers allows high extrusion rates and high spinning speeds. In the present invention the term “spinning speed” means the rate at which the finished fiber is wound or deposited on a substrate and is typically measured as meters per minute. High extrusion rate and spinning speed is important from a practical sense since commercial equipment operates at high extrusion rates and spinning speeds. In this way, commercially attractive rates can be achieved. In the present invention, spinning speeds of at least 500 meters per minute (mpm) are required. More preferred are spinning speeds of at least 1000 mpm and most preferred are spinning speeds or at least 2000 mpm. The term “polymer throughput” means the rate at which the fiber composition is extruded from the spinnerets and is typically measured in grams of polymer per hole per minute.

For the applications disclosed herein, fine denier fibers are preferred. These fine denier fibers are extremely efficient elastic materials in the sense that very small amounts of material can be used to affect elastic behavior in articles so composed. In the present invention bicomponent fibers having a denier (grams per 9000 m fiber) from 0.1 to 30 can be made. More preferred are fibers having a denier from 0.5 to 20 and most preferred are fibers having a denier from 1 to 10.

### EXAMPLES

The term “elastic” is used herein to mean any material which, upon application of a biasing force, is stretchable, that is, elongatable at least about 60 percent (i.e., to a stretched, biased length which is at least about 160 percent of its relaxed unbiased length) and which, will recover at least 50 percent of its elongation upon release of the stretching, elongating force. A hypothetical example would be a one (1) inch sample of a material which is elongatable to at least 1.60 inches (4.06 cm) and which, upon being elongated to 1.60 inches (4.06 cm) and released, will recover to a length of not more than 1.30 inches (3.30 cm). Many elastic materials may be elongated by much more than 60 percent (i.e., much more than 160 percent of their relaxed length), for example, elongated 100 percent or more, and many of these will recover to substantially their initial relaxed length, for example, to within 105 percent of their initial relaxed length, upon release of the stretching force.

The elasticity was measured on yarns formed from the elastomeric fibers. The yarn consisted of 72 individual continuous fibers. The yarn was pre-stretched to 100 percent elongation and allowed to relax. The yarn was then cyclically elongated to 50 percent elongation at a rate of 10 inches per minute for one cycle. The elasticity was determined as the percent of recovered elongation.

As used herein, the term “tenacity” refers to the measure of tensile strength of a yarn as measured in grams per denier.

### Examples 1-10

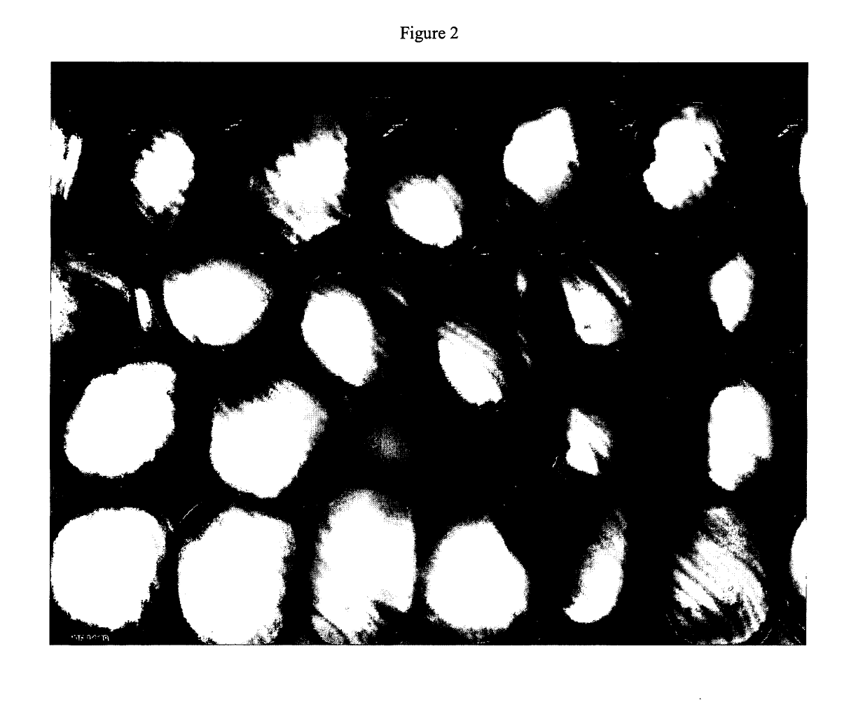

Bicomponent fibers with a polypropylene sheath and a controlled distribution block copolymer core at sheath/core ratios of 30/70 and 20/80 were made and tested. FIG. 2 shows representative fibers before winding having a 20/80 sheath/core ratio. The polypropylene sheath was a homopolymer (5D49) from The Dow Chemical Company having a nominal 38 melt flow rate (MFR, 230° C., 2.16 kg). The controlled distribution block copolymer (Polymer A) was a linear, coupled block copolymer having a controlled distribution styrene ethylene/butylene midblock. The total styrene equivalent peak molecular weight of Polymer A was 68,300 and the total styrene content was 47% wt. The styrene endblock had a peak molecular weight of 7,200. The controlled distribution midblock contained 25% styrene monomer basis the total styrene plus butadiene of the midblock. The styrene blockiness of the midblock was 3% indicating a high degree of separation of styrene, units only achievable by controlled distribution synthetic protocols. The coupling efficiency of the polymer was 95%. The melt flow rate was 55 g/10 minutes at 230° C. and 2.16 kg. The fibers were made via a conventional high speed spinning process using bicomponent technology and spinnerets from Hills Inc. The spinneret hole size was 0.35 mm and there were 72 holes. The polymer throughput was 0.77 g/hole/min. Table 1 gives typical spinning performance and mechanical properties of the fibers. From Table 1 one can see that fine denier fibers were achieved at high spinning speeds (examples 5, 6, 9 and 10). The fibers also possessed good fiber tensile strength and high elongation to break. The elastic performance is also very good for all of the examples as shown by the elasticity measurements.

TABLE 1

| | | Spinning | | Elongation | Denier Per | |
|---|---|---|---|---|---|---|
| | Sheath/Core | Speed | Tenacity | at Break | Filament | Elasticity |
| Example | Ratio | (mpm) | (g/dn) | (%) | (dpf) | (%) |
| 1 | 30/70 | 1000 | 1.0 | 340 | 6.2 | NT |
| 2 | 30/70 | 1500 | 1.4 | 250 | 4.8 | 60 |
| 3 | 30/70 | 2000 | 1.5 | 180 | 4.0 | 48 |
| 4 | 30/70 | 2500 | 1.7 | 130 | 3 | 54 |
| 5 | 30/70 | 3000 | 1.9 | 140 | 2.7 | 48 |
| 6 | 30/70 | 3500 | 2.2 | 120 | 2.1 | 50 |
| 7 | 20/80 | 1500 | 1.3 | 280 | 5.5 | 74 |
| 8 | 20/80 | 2000 | 1.4 | 190 | 3.9 | 60 |
| 9 | 20/80 | 2500 | 1.4 | 170 | 2.8 | 58 |
| 10 | 20/80 | 3000 | 1.4 | 150 | 2.6 | 54 |

NT: not tested

### Comparative Examples 11-14

Examples 11-14 represent mono-component fibers from the neat Polymer A and polypropylene (5D49). The fibers were extruded using the process of examples 1-10. However, only a single component was extruded for each comparative example. Both components were not simultaneously coextruded. The spinneret hole size was 0.35 mm with 72 holes. The polymer throughput was 0.77 g/hole/min. Comparative example 11, the monofilament with Polymer A alone, was spinnable but the yarns were excessively sticky. The fibers blocked upon winding. During a spunbond process it is important that the fibers not stick to each other to insure the formation of a uniform fabric. Comparative examples 12-14 illustrate fibers made from polypropylene alone. Polypropylene can offer excellent spinning performance and tensile strength. However, the elastic performance is poor compared to the inventive examples 1-10. The inventive examples 1-10 possess a combination of good tensile strength and excellent elastic performance.

TABLE 2

| | | Spinning Speed | Tenacity | Elongation | Elasticity | |
|---|---|---|---|---|---|---|
| Example | Polymer | (mpm) | (g/dn) | at Break (%) | (%) | dpf |
| 11 | Polymer A | 1000 | 1.1 | 440 | 95 | 7.1 |
| 12 | 5D49 | 1500 | 2.2 | 340 | 40 | 5 |
| | Polypropylene | | | | | |
| 13 | 5D49 | 2000 | 2.5 | 270 | 42 | 3.8 |
| | Polypropylene | | | | | |
| 14 | 5D49 | 3000 | 2.6 | 230 | 46 | 2.5 |
| | Polypropylene | | | | | |

### Example 15

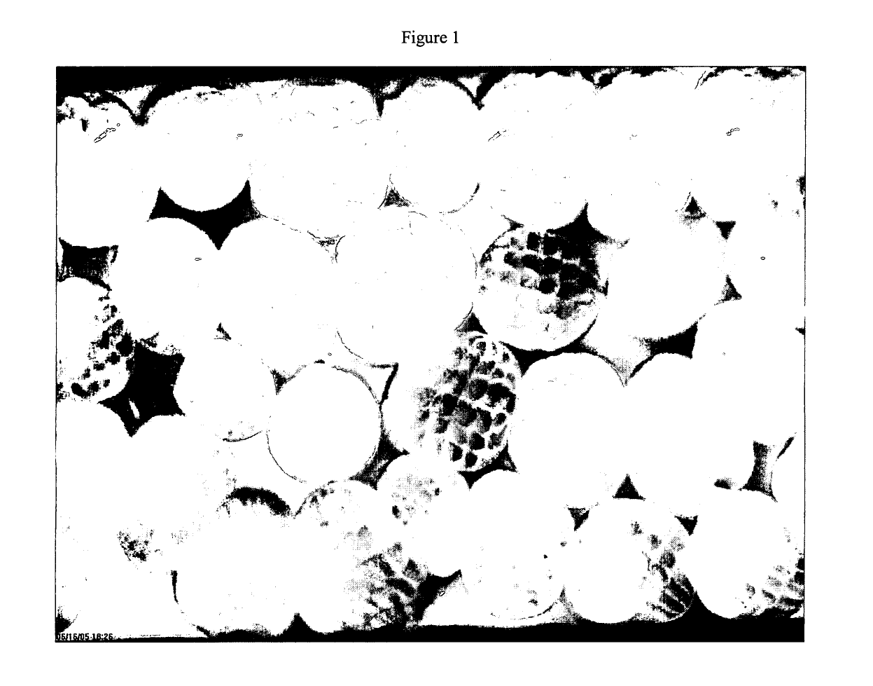

Bicomponent fibers were coextruded using the method of examples 1-10 using a spinneret having an islands-in-the-sea configuration with 36 islands. FIG. 1 shows the fibers so made. The spinneret hole size was 0.35 mm and there were 72 holes. The polymer throughput was 0.77 g/hole/min. Bicomponent fibers with a polypropylene sea and Polymer A islands at a 20/80 sea/island ratio. The polypropylene sea was homopolymer 5D49 from The Dow Chemical Company. The elastomer core was Polymer A. The spinning performance and mechanical properties for this spinning configuration are given in Table 3. One can see that high speed spinning and fine fibers were achieved having good fiber tensile strength and high elongation to break. The comparable sheath-core bicomponent fiber was made as example 9. The equivalent fiber having an island-in-the-sea morphology had significantly higher elongation and was noticeably softer to the touch.

TABLE 3

| | Sea/ | Spinning | | Elongation | | |
|---|---|---|---|---|---|---|
| | Island | Speed | Tenacity | at Break | | |
| Example | Ratio | (mpm) | (g/dn) | (%) | dpf | Elasticity |
| 15 | 20/80 | 2500 | 1.6 | 360 | 3.1 | 56 |

### Examples 16-21

Bicomponent fibers were also spun via a single 6 inch wide aspirator (Hills Inc design) to simulate a spunbond process. The spinneret hole size was 0.35 mm with 72 holes. Examples 16-21 in Table 4 demonstrate that elastic nonwoven fabrics can be made using sheath/core elastic fibers and a spunbond process. The sheath was polypropylene (5D49) and the elastomer core was Polymer A. Air pressure in the aspirator was used to help define the maximum spinning speed, i.e., the higher the pressure the higher the spinning speed. For all of the examples the polymer throughput per spinneret hole (0.77 g/hole/min) was the same. Spinning speeds were estimated from the final fiber diameter.

TABLE 4

| | | Air | Spinning | |
|---|---|---|---|---|
| | Sheath/Core | Pressure | Speed | |
| Example | Ratio | (psig) | (mpm) | dpf |
| 16 | 50/50 | 30 | 3700 | 2.2 |
| 17 | 50/50 | 40 | 4300 | 1.95 |
| 18 | 30/70 | 30 | 3700 | 2.2 |
| 19 | 30/70 | 40 | 4500 | 1.7 |
| 20 | 20/80 | 30 | 2500 | 3.5 |
| 21 | 20/80 | 35 | 2900 | 2.8 |

### Examples 22-23 and Comparative Example 24

Elastomeric fibers were made comprising Polymer A and 0.5 wt % of Crodamide VRX slip agent (examples 22 and 23). As a comparison, neat Polymer A fibers were also made (comparative example 24). These single component fibers were processed using a conventional high speed spinning process with spinnerets from Hills Inc. The spinneret hole size was 0.35 mm and there were 72 holes. The polymer throughput was 0.77 g/hole/min. Fiber examples 22 and 23 were not sticky and were suitable for high speed fiber spinning processes. Comparative fiber example 24 was sticky and fibers so made were difficult to separate. While sticky fibers may find utility in high speed melt-blown processes where bonding of fibers is desirable, the comparative fibers were not suitable for high speed spunbond processes. These single component fibers show high elasticity.

TABLE 5

| | Spinning | | Elongation | | |
|---|---|---|---|---|---|
| | Speed | Tenacity | at Break | | Elasticity |
| Example | (mpm) | (g/dn) | (%) | dpf | (%) |
| 22 | 1000 | 0.6 | 430 | 6.6 | 72 |
| 23 | 1500 | 1.1 | 460 | 4.3 | 88 |
| 24 | 1000 | 1.1 | 440 | 7.1 | 95 |

### Example 25

Bicomponent fibers were made according to the method of examples 1-10 having a polyamide sheath and Polymer A as the elastomer core at a 20/80 sheath/core ratio. The polyamide sheath in example 25 was BASF nylon 6 grade (BS 400) with a relative viscosity of 2.4-2.46. The fibers were made via a conventional high speed spinning process using bicomponent technology and spinnerets from Hills Inc. The spinneret hole size was 0.35 mm and there were 72 holes. The polymer throughput was approximately 0.8 g/hole/min. Table 6 gives typical spinning performance and mechanical properties of the fibers. Fine diameter fibers with excellent tensile and elasticity properties were obtained.

TABLE 6

| | | Spinning | | Elongation | Denier Per | |
|---|---|---|---|---|---|---|
| | Sheath/Core | Speed | Tenacity | at Break | Filament | |
| Example | Ratio | (mpm) | (g/dn) | (%) | (dpf) | Elasticity (%) |
| 25 | 20/80 | 2500 | 1.5 | 356 | 3.3 | 44 |

### Example 26

Bicomponent fibers were made according to the method of examples 1-10 having a polyester sheath and Polymer A as the elastomer core at a 20/80 sheath/core ratio. The polyester sheath was poly(trimethylene terephthalate) (PTT) (Shell Chemical Co., 2700 series) and had an LVN of 0.92. The fibers were made via a conventional high speed spinning process using bicomponent technology and spinnerets from Hills Inc. The spinneret hole size was 0.35 mm and there were 72 holes. The polymer throughput was approximately 0.8 g/hole/min. Table 7 gives typical spinning performance and mechanical properties of the fibers. Fine diameter fibers with excellent initial tensile properties were obtained.

TABLE 7

| | | Spinning | | Elongation | Denier Per | |
|---|---|---|---|---|---|---|
| | Sheath/Core | Speed | Tenacity | at Break | Filament | |
| Example | Ratio | (mpm) | (g/dn) | (%) | (dpf) | Elasticity (%) |
| 26 | 20/80 | 2500 | 1.4 | 390 | 3.8 | NT |

NT: not tested

We claim:

1. A bicomponent fiber comprising a thermoplastic polymer and an elastomeric compound wherein the elastomeric compound comprises a selectively hydrogenated block copolymer having the general configuration A-B, A-B-A, (A-B)ₙ, (A-B-A)ₙ, (A-B-A)ₙX, (A-B)ₙX or mixtures thereof where n is an integer from 2 to about 30, and X is coupling agent residue and wherein:
a. prior to hydrogenation each A block is a mono alkenyl arene polymer block and each B block is a controlled distribution copolymer block of at least one conjugated diene and at least one mono alkenyl arene;
b. subsequent to hydrogenation about 0-10% of the arene double bonds have been reduced, and at least about 90% of the conjugated diene double bonds have been reduced;
c. each A block having a number average molecular weight between about 3,000 and about 60,000 and each B block having a number average molecular weight between about 30,000 and about 300,000;
d. each B block comprises terminal regions adjacent to the A block that are rich in conjugated diene units and one or more regions not adjacent to the A block that are rich in mono alkenyl arene units;
e. the total amount of mono alkenyl arene in the hydrogenated block copolymer is about 20 percent weight to about 80 percent weight; and
f. the weight percent of mono alkenyl arene in each B block is between about 10 percent and about 75 percent;
g. each block B has a mono alkenyl arene blockiness index of less than 40 mol %, said mono alkenyl arene blockiness index being the proportion of mono alkenyl arene units in the block B having two mono alkenyl arene neighbors on the polymer chain; and
h. the melt index of the block copolymer is greater than or equal to 12 grams/10 minutes according to ASTM D1238 at 230° C. and 2.16 kg weight.

2. The bicomponent fiber of claim 1 wherein the block copolymer has an order-disorder transition temperature (ODT) of less than 250° C.

3. The bicomponent fiber of claim 1 wherein said conjugated diene is butadiene, and wherein about 20 to about 40 mol percent of the condensed butadiene units in the B block have 1,2-configuration.

4. The bicomponent fiber of claim 1 wherein the styrene blockiness index of the block B is less than about 10 percent.

5. The bicomponent fiber of claim 1 wherein said mono-alkenyl arene is styrene and said conjugated diene is selected from the group consisting of isoprene and butadiene.

6. The bicomponent fiber of claim 5 wherein the weight percentage of styrene in the B block is between about 10 weight percent and about 50 weight percent, and the styrene blockiness index of the block B is less than about 25 percent, said styrene blockiness index being the proportion of styrene units in the B block having two styrene neighbors on the polymer chain.

7. The bicomponent fiber of claim 1 wherein said conjugated diene is butadiene, and wherein about 20 to about 80 mol percent of the condensed butadiene units in the block B have 1,2-configuration.

8. The bicomponent fiber of claim 1 wherein said A block has a glass transition temperature of plus 80° C. to plus 110° C. and said B block has a single glass transition temperature of at least above about minus 60° C.

9. The bicomponent fiber of claim 1 wherein the coupling agent residue derives from coupling agents selected from the group consisting of divinyl arenes, silicon halides, alkoxy silanes, aliphatic epoxies, glycidyl aromatic epoxies, and diesters.

10. The bicomponent fiber of claim 9 wherein the coupling agent is selected from the group consisting of tetramethoxy silane, tetraethoxy silane, tetrabutoxy silane, tetrakis(2-ethylhexyloxy) silane, methyl trimethoxy silane, methyl triethoxy silane, isobutyl trimethoxy silane and phenyl trimethoxy silane.

11. The bicomponent fiber of claim 1 wherein the elastomeric compound core is further comprised of up to 50% by weight of a thermoplastic polymer selected from the group consisting of polypropylene, linear low density polyethylene, polystyrene, polyamides, and polyesters.

12. The bicomponent fiber of claim 11 wherein the polyester is selected from the group consisting of poly(ethylene terephthalate), poly(butylene terephthalate), and poly(trimethylene terephthalate).

13. The bicomponent fiber of claim 1 having a sheath-core morphology wherein the core consists of the elastomeric compound and the sheath consists primarily of the thermoplastic polymer.

14. The bicomponent fiber of claim 13 wherein the volume ratio of thermoplastic polymer sheath to elastomeric compound core is from 1/99 to 50/50.

15. The bicomponent fiber of claim 1 having an islands-in-the-sea morphology wherein the islands consist primarily of the elastomeric compound and the sea consists primarily of the thermoplastic polymer.

16. The bicomponent fiber of claim 15 wherein the volume ratio of thermoplastic polymer sea to elastomeric compound islands is from 1/99 to 50/50.

17. The bicomponent fiber of claim 1 wherein the melt flow rate of the block copolymer is at least 40 g/10 min at 230° C. and 2.16 kg weight according to ASTM D1238.

18. The bicomponent fiber of claim 1 wherein the thermoplastic polymer is selected from the group consisting of polypropylene, linear low density polyethylene, polystyrene, polyamides, poly(ethylene terephthalate), poly(butylene terephthalate), and poly(trimethylene terephthalate).

19. The bicomponent fiber of claim 18 wherein the thermoplastic polymer is polypropylene having a melt flow of at least 20 g/10 min at 230° C. and 2.16 kg according to ASTM D1238.

20. The bicomponent fiber of claim 18 wherein the thermoplastic polymer is poly(trimethylene terephthalate).

21. The bicomponent fiber of claim 18 wherein the thermoplastic polymer is nylon 6.

22. An article comprising the bicomponent fiber of claim 1 which is an elastic mono-filament, a woven fabric, a spunbond non-woven fabric, a melt-blown non-woven fabric or filter, a staple fiber, a yarn or a bonded, carded web.

23. A process to produce the bicomponent fiber of claim 1 having a sheath-core or islands-in-the-sea morphology comprising coextrusion of a thermoplastic polymer and an elastomeric compound wherein the thermoplastic polymer and the elastomeric compound are forced using separate melt pumps to extrude through a die to form one or more fibers having a sheath primarily consisting of the thermoplastic polymer and a core primarily consisting of the elastomeric compound at a spinning speed of at least 1000 meters per minute such that the bicomponent fiber has a denier per filament from 0.1 to 30 grams per 9000 meters.

24. The process of claim 23 wherein the bicomponent fibers have a denier per filament from 1 to 10 grams per 9000 meters.

25. The process of claim 23 wherein the spinning speed is at least 2000 meters per minute.

26. An elastomeric fiber consisting essentially of from 0.01 to 2.0 parts by weight of a slip agent and from 99.99 to 95 parts by weight of an elastomeric compound wherein the elastomeric compound comprises a selectively hydrogenated block copolymer having the general configuration A-B, A-B-A, (A-B)ₙ, (A-B-A)ₙ, (A-B-A)ₙX, (A-B)ₙX or mixtures thereof where n is an integer from 2 to about 30, and X is coupling agent residue and wherein:
a. prior to hydrogenation each A block is a mono alkenyl arene polymer block and each B block is a controlled distribution copolymer block of at least one conjugated diene and at least one mono alkenyl arene;
b. subsequent to hydrogenation about 0-10% of the arene double bonds have been reduced, and at least about 90% of the conjugated diene double bonds have been reduced;
c. each A block having a number average molecular weight between about 3,000 and about 60,000 and each B block having a number average molecular weight between about 30,000 and about 300,000;
d. each B block comprises terminal regions adjacent to the A block that are rich in conjugated diene units and one or more regions not adjacent to the A block that are rich in mono alkenyl arene units;
e. the total amount of mono alkenyl arene in the hydrogenated block copolymer is about 20 percent weight to about 80 percent weight; and
f. the weight percent of mono alkenyl arene in each B block is between about 10 percent and about 75 percent;
g. each block B has a mono alkenyl arene blockiness index of less than 40 mol %, said mono alkenyl arene blockiness index being the proportion of mono alkenyl arene units in the block B having two mono alkenyl arene neighbors on the polymer chain; and
h. the melt index of the block copolymer is greater than or equal to 12 grams/10 minutes according to ASTM D1238 at 230° C. and 2.16 kg weight.

27. The elastomeric fiber of claim 26 wherein the slip agent is selected from the group consisting of amides, metallic stearates, waxes, silicones, and fluorinated acrylics, silicones and olefins.

28. The elastomeric fiber of claim 27 wherein the slip agent is an amide selected from the group consisting of stearamide, oleamide and erucamide.

29. The elastomeric fiber of claim 28 wherein the slip agent is oleamide.

30. The elastomeric fiber of claim 26 comprising from 0.1 to 1.0 parts by weight of the slip agent and from 99.9 to 98 parts by weight of the elastomeric compound.

31. The elastomeric fiber of claim 26 wherein the styrene blockiness index of the block B is less than about 10 percent.

32. The elastomeric fiber of claim 26 wherein said mono-alkenyl arene is styrene and said conjugated diene is selected from the group consisting of isoprene and butadiene.

33. The elastomeric fiber of claim 26 wherein the weight percentage of styrene in the B block is between about 10 weight percent and about 50 weight percent, and the styrene blockiness index of the block B is less than about 25 percent, said styrene blockiness index being the proportion of styrene units in the B block having two styrene neighbors on the polymer chain.

34. The elastomeric fiber of claim 26 wherein said conjugated diene is butadiene, and wherein about 20 to about 80 mol percent of the condensed butadiene units in the block B have 1,2-configuration.

35. An article comprising the elastomeric fiber of claim 26 which is an elastic mono-filament, a woven fabric, a spunbond non-woven fabric, a melt-blown non-woven fabric or filter, a staple fiber, a yarn or a bonded, carded web.
